(19) United States
(12) Patent Application Publication
(10) Pub. No.: US 2005/0077122 A1
(43) Pub. Date: Apr. 14, 2005

(54) Clip on electronic lining wear sensor

(76) Inventors: Bruce V. Harris, Shelby Township, MI (US); Josesph A. Kay, Highland, MI (US); Thomas Michael Cory, Sterling Heights, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/685,110

(22) Filed: Oct. 14, 2003

(51) Int. Cl. F16D 55/00

(52) U.S. Cl. 188/71.1

(57) ABSTRACT

An electronic sensor for a vehicle braking system comprises an electrically conducting member housed inside an insulating body. A clip is adapted to receive the sensor and attached to a braking element of the vehicle braking system, preferably between adjacent portions of a brake lining. The clip is placed at a predetermined location such that a braking surface wears down only the brake lining without contacting the conducting member until the lining is sufficiently worn. At that time, the conducting member is separated to break an electrical circuit and provide an electronic signal.

### BACKGROUND OF THE INVENTION

This invention relates to electronic wear detection probes or sensors for vehicle braking elements.

Brake lining wear sensors are well known and used in the prior art. Brake shoes and brake pads are composed of a suitable friction lining material mounted onto a metal back plate or table. The lining contacts the disc or drum, creates drag, and slow down the vehicle. Over time, the contact between the lining and the disc or drum causes the lining to wear. Thus it is desirable to provide an indication of when brake lining thickness is sufficiently worn to warrant changing of the lining.

Typical electronic sensors that act as indicators are expensive and somewhat difficult to attach to brake shoes or pads. Such sensors are often molded directly into the brake lining material and therefore must be designed for use with a specific brake shoe or pad. This makes it very difficult, if not impossible, to modify a sensor manufactured for use on one vehicle braking system for use on a different vehicle braking system. It is therefore a goal of the present invention to provide a low cost lining wear sensor that easily clips on to any brake shoe or pad.

### SUMMARY OF THE INVENTION

The present invention includes a sensor comprising an electrically conducting member with a linkage portion housed inside an insulating body. The sensor is adapted for connection to a vehicle electronics system. The sensor is inserted into a clip which securely mounts on to a table of either a brake shoe or a brake pad, preferably between adjacent portions of a brake lining in the case of a brake shoe. A braking surface, either a brake drum or a brake rotor, at first wears away only the brake lining. However, the sensor is placed at a predetermined location such that the braking surface wears away the linkage portion of the conducting member to separate the conducting member into two to break an electrical circuit and provide an electronic signal when the lining is sufficiently worn.

Thus the invention offers an electronic sensor that is easy to attach to both brake shoes and brake pads by way of an inexpensive clip. Further, the sensor can be used with different vehicle braking systems simply by changing the clip, thus further decreasing overall costs. If desired, it is also possible to reuse the clip with a different braking system by removing the clip from one braking system and placing it on another braking system, changing the sensor if necessary.

### BRIEF DESCRIPTION OF THE DRAWINGS

FIG. 1 is a perspective view of a portion of a vehicle drum brake system in accordance with a first embodiment of the present invention;

FIG. 2 is a detail of FIG. 1 showing a brake shoe table, a clip attached to the table, and a sensor received in the clip according to the present invention;

FIG. 3 is a side view of FIG. 2;

FIG. 4 is a detail of FIG. 2 showing the clip detached from the table and the sensor removed from the clip;

FIG. 5 is a side view of FIG. 4;

FIG. 6 is a detail of the clip and the sensor of the present invention; and

FIG. 7 shows the sensor received in a passage in the clip of the present invention.

FIG. 8 is a side view showing a portion of a vehicle disc brake system in accordance with a second embodiment of the present invention.

### DETAILED DESCRIPTION OF PREFERRED EMBODIMENTS

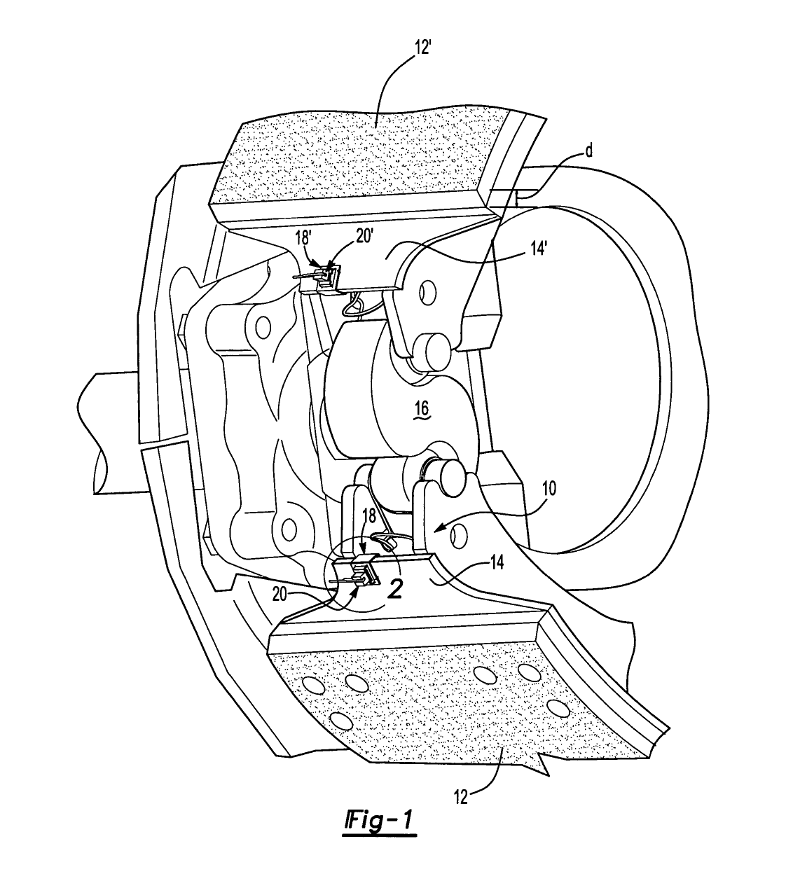

FIG. 1 shows a perspective view of a portion of a vehicle drum brake system in accordance with a first embodiment 10 of the present invention. The drum brake system includes a drum (not shown) with an inner surface (not shown) disposed about an axis of rotation A for frictionally engaging a brake lining (not shown). A pair of brake shoes 12, 12′ located adjacent the inner surface of the drum each include a backing plate comprising a table 14, 14′ and at least one brake lining segment (not shown). An actuator manipulates an S-cam 16 to move the shoes 12, 12′ into contact with the inner surface of the drum to provide a braking force, which is well known in the art.

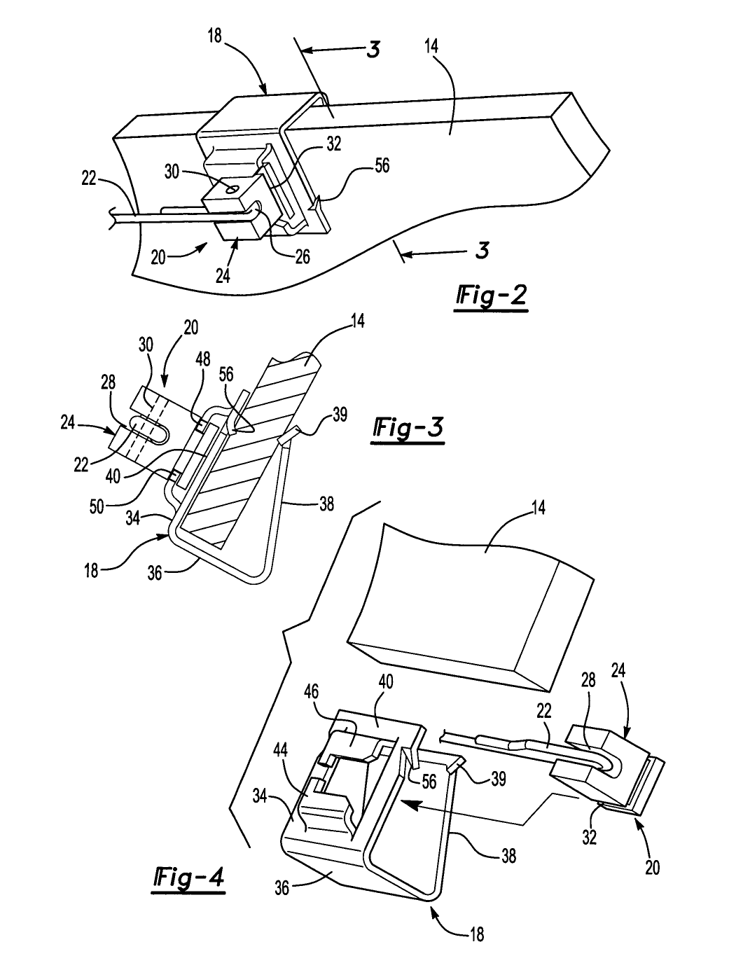

Referring to FIG. 2, a clip 18 receives a sensor 20 and attaches to the brake shoe table 14, preferably between adjacent portions of the brake lining. Throughout this description, it should be understood that an additional clip 18′ receives an additional sensor 20′ in a like manner for connection to the second brake shoe table 14′. For ease of explanation, only one set of parts will be described. However, if desired only one sensor may be used. The sensor 20 comprises an electrically conducting member 22 housed within an insulating member 24. The conducting member 22 includes a linkage portion 26 and is adapted for connection to a vehicle electronics system. As shown in FIG. 3, the top of the insulating member 24 includes a channel 28 for receiving the conducting member 22. A pin 30 secures the conducting member 22 within the channel 28.

Turning now to FIG. 4, the base of the insulating member 24 includes a groove 32 for insertion into the clip 18. The clip 18 includes a front portion 34, a top portion 36 and a base portion 38 integrally formed with one another. The top portion 36 is formed at approximately a 90 degree angle to the front portion 34, while the base portion 38 is formed at less than a 90 degree angle to the top portion 36. Thus, when the clip 18 is received on the table 14, the base portion 38 is biased away from the front portion 34. When the two portions 34, 38 return to their relaxed positions, the resultant resisting force holds the clip 18 in place on the table 14 with the top portion 36 preferably flush against the table 14. The base portion 38 preferably includes a base barb 39 at the end of the base portion 38 opposite the top portion 36 for maintaining the position of the clip 18 on the table 14.

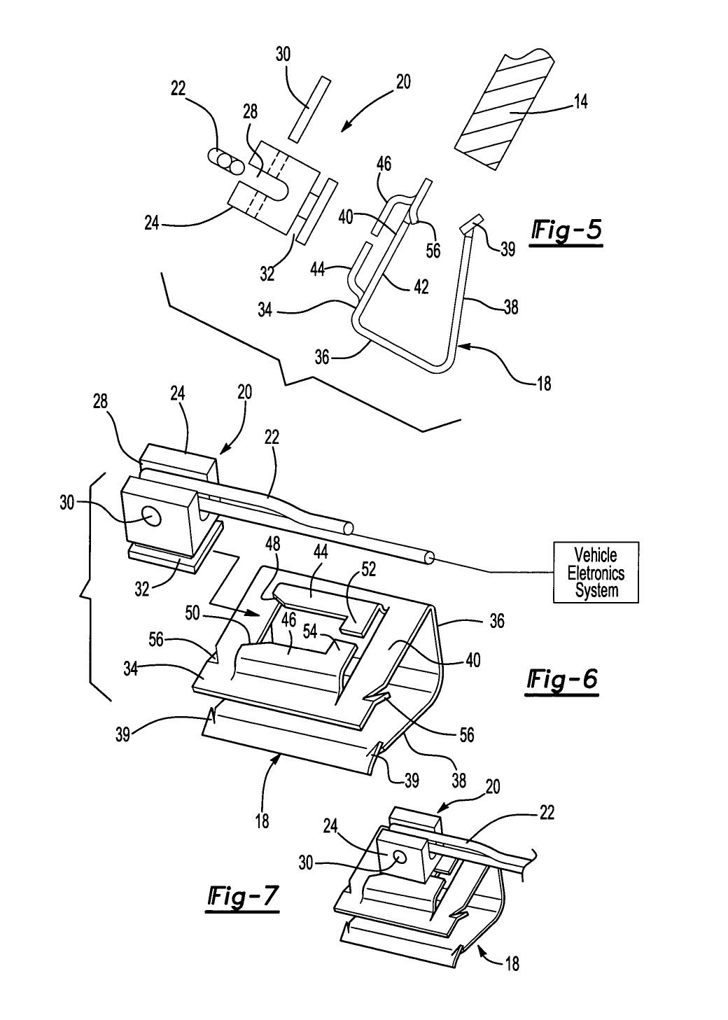

Referring to FIG. 5, the front portion 34 includes a front surface 40 for receiving the sensor 20 and a back surface 42 for engaging the table 14. The front surface 40 includes two arcuate projections 44, 46 surrounding an opening for retaining the sensor 20. As best shown in FIGS. 5-7, the projections 44, 46 include chamfers 48, 50 and retaining tabs 52, 54. The groove 32 of the base of the insulating member 24 of the sensor 20 fits between the arcuate projections 44, 46 beginning at the chamfered ends 48, 50. The retaining tabs 52, 54 keep the sensor 20 in position within the clip 18. The back surface 42 preferably contains a front barb 56, preferably toward the end of the back surface 42 furthest from the top portion 36. The front barb 56 helps to keep the clip 18 in place on the table 14.

When the vehicle braking system is in operation, the brake drum at first wears away only the brake lining. However, the sensor 20 is placed at a predetermined location such that the drum wears away the linkage portion 26 of the conducting member 22 to separate the conducting member 22 into two when the lining is sufficiently worn, thus breaking an electrical circuit. In the preferred embodiment, an electronic signal is generated when the circuit is broken to provide a warning that the brake lining thickness is below a predetermined thickness d, shown in FIG. 1. The electronic signal may be audible or visual, but is not limited thereto.

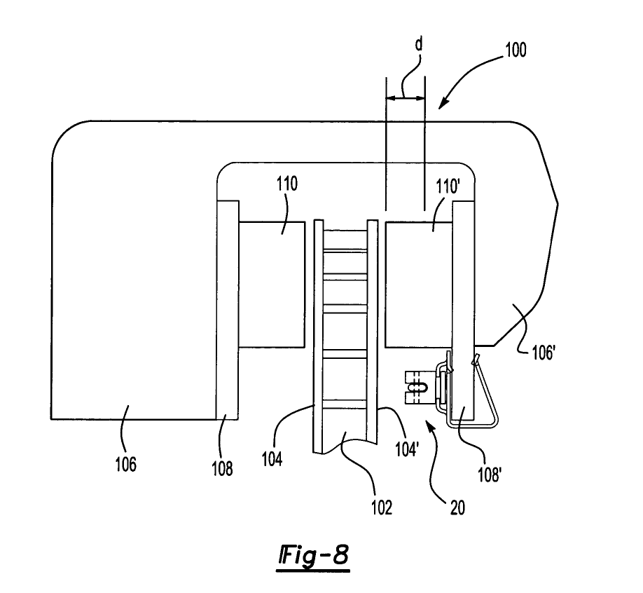

In a second disclosed embodiment of the present invention, as shown in FIG. 8, the electronic lining wear sensor 20 is similarly used to detect wear in a vehicle disc brake system 100. The disc brake system includes a rotor 102 with a pair of outer surfaces 104, 104′ disposed about an axis of rotation for frictionally engaging a brake lining material 110, 110′. A pair of brake pads 106, 106′, one located adjacent each outer surface of the rotor 100, each include a backing plate 108, 108′ and at least one brake lining segment 110, 110′. An actuator moves the pads into contact with the outer surfaces of the rotor to provide a braking force, which is well known in the art. In accordance with the second embodiment, a clip 18 receives a sensor 20 and attaches to the brake pad table 110, 110′, preferably between adjacent portions of the brake lining 110, 110′ as described above. For a time, the rotor 102 wears away the lining 110, 110′ without contacting the sensor. When the lining 110, 110′ is sufficiently worn, the rotor 102 wears away the linkage portion 26 of the conducting member 22 and separates the conducting member 22 into two, breaking the electrical circuit and providing an electronic signal that the brake lining 110, 110′ is below a predetermined thickness d.

Thus the invention offers an electronic sensor that is easy to attach to both brake shoes and brake pads by way of an inexpensive clip. Further, the sensor can be used with different vehicle braking systems simply by changing the clip, thus further decreasing overall costs.

The preferred embodiments of the invention have been disclosed. However, a worker of ordinary skill in this art would recognize that certain modifications would come within the scope of this invention. For that reason the following claims should be studied to determine the true scope and content of this invention.

1. A vehicle brake assembly comprising:
a braking element rotatable about an axis;
a friction member including a backing plate with a brake lining attached thereto;
an actuator moving said friction member into contact with said braking element to provide a braking force such that said brake lining gradually wears away each time the braking force is generated;
a clip removably secured to said friction member; and
an electronic lining wear sensor supported by said clip generating a signal with said brake lining at a predetermined thickness.

2. The vehicle brake assembly as recited in claim 1, wherein said clip includes a first portion, a second portion and a third portion integrally formed with one another forming a U-shaped.

3. The vehicle brake assembly as recited in claim 2, wherein said second portion is formed at approximately a 90 degree angle to said first portion, and wherein said third portion is formed at less than a 90 degree angle to said second portion, such that said third portion is biased away from said first portion generating a resisting force holding said clip in place on said table.

4. The vehicle brake assembly as recited in claim 2, wherein said first portion includes a first barb for engaging said table.

5. The vehicle brake assembly as recited in claim 2, wherein said third portion includes a second barb for engaging said table.

6. The vehicle brake assembly as recited in claim 1, wherein said sensor includes a groove and said clip includes a pair of projections received in said groove.

7. The vehicle brake assembly as recited in claim 6, wherein said projections include retaining tabs providing a stop for said sensor.

8. The vehicle brake assembly as recited in claim 1, wherein said sensor comprises an electrically conducting member housed within a channel in an insulating member with said insulator received by said clip, and wherein said conducting member is secured within said channel by a pin.

9. The vehicle brake assembly as recited in claim 8, wherein said conducting member includes a linkage portion, and wherein said clip is positioned on said table with said linkage portion severed at said predetermined thickness.

10. The vehicle brake assembly as recited in claim 9, wherein said signal is sent to a vehicle electronics system with said linkage portion severed.

11. A vehicle brake assembly comprising:
a U-shaped clip;
an electronic lining wear sensor supported by said clip, said clip including a linkage portion defining a circuit; and
a vehicle electronic system electrically connected to said linkage portion generating a signal with said circuit broken.

12. The vehicle brake assembly as recited in claim 11, wherein said clip includes opposing barbs extending toward one another.

13. The vehicle brake assembly as recited in claim 11, wherein said sensor includes a groove and said clip includes a pair of projections received in said groove.

14. The vehicle brake assembly as recited in claim 13, wherein said projections include retaining tabs providing a stop for said sensor.

15. The vehicle brake assembly as recited in claim 11, wherein said sensor includes an insulating member having a channel with said linkage portion disposed within said channel, said linkage portion secured to said insulator by a pin.
